(19) United States
(12) Patent Application Publication
(10) Pub. No.: US 2012/0076719 A1
(43) Pub. Date: Mar. 29, 2012

(54) METHOD FOR ACTIVATING CATALYST FOR CHLORINE PRODUCTION AND METHOD FOR PRODUCING CHLORINE

(76) Inventor: Youhei Uchida, Hyogo (JP)

(21) Appl. No.: 13/322,897

(22) PCT Filed: May 19, 2010
(86) PCT No.: PCT/JP2010/058435

§ 371 Date: Nov. 28, 2011

(30) Foreign Application Priority Data
May 29, 2009 (JP) 2009-130990

(51) Int. Cl. C01B 7/04; B01J 23/46; B01J 37/00

(52) U.S. Cl. 423/502; 502/100; 502/325

(57) ABSTRACT

A method for activating a catalyst for chlorine production used in a reaction for oxidizing hydrogen chloride with oxygen, including the step of bringing a catalyst for chlorine production having decreased activity into contact with a basic liquid, and a method for producing chlorine by oxidizing hydrogen chloride with oxygen in the presence of a catalyst for chlorine production activated by the above method are provided. The basic liquid used preferably has a pH of 8 or more, and is preferably an aqueous solution in which an inorganic base is dissolved. The catalyst for chlorine production is preferably a catalyst containing ruthenium oxide.

### TECHNICAL FIELD

The present invention relates to a method for activating a catalyst for chlorine production having decreased activity, and to a method for producing chlorine using a catalyst for chlorine production activated by this method.

### BACKGROUND ART

Chlorine is useful as a raw material of vinyl chloride, phosgene, and the like, and has conventionally been produced by a reaction for oxidizing hydrogen chloride with oxygen in the presence of a catalyst for chlorine production. However, the catalyst for chlorine production used in the above-mentioned reaction has sometimes showed decrease in catalytic activity when, for example, it was subjected to a thermal load under steady or unsteady conditions.

Thus, methods for activating a catalyst for chlorine production having decreased activity (hereinafter sometimes also referred to as a “deteriorated catalyst”) have been proposed, for example, a method wherein a deteriorated catalyst is brought into contact with a gas consisting essentially of oxygen and/or an inert gas [Japanese Patent Laying-Open No. 2007-7521 (PTL 1)], and a method wherein a deteriorated catalyst is subjected to a contact treatment with a reducing gas containing carbon monoxide and/or hydrogen [Japanese Patent Laying-Open No. 2009-22917 (PTL 2)].

### Citation List

### Patent Literature

PTL 1: Japanese Patent Laying-Open No. 2007-7521

PTL 2: Japanese Patent Laying-Open No. 2009-22917

### SUMMARY OF INVENTION

### Technical Problem

However, catalysts for chlorine production activated by the conventional activation methods described above have not necessarily provided sufficiently satisfactory catalytic activity.

Thus, an object of the present invention is to provide a method for activating a catalyst for chlorine production capable of effectively activating a catalyst for chlorine production having decreased activity, so as to recover the catalytic activity satisfactorily, and a method for producing chlorine using a catalyst activated by the method.

### Solution To Problem

The present inventors conducted extensive research in order to solve the above-mentioned problem. Consequently, the inventors found that the catalytic activity can be effectively recovered by a simple method wherein a catalyst having decreased activity is brought into contact with a basic liquid, thereby completing the present invention.

In summary, the present invention includes the following features.

(1) A method for activating a catalyst for chlorine production used in a reaction for oxidizing hydrogen chloride with oxygen, including the step of bringing a catalyst for chlorine production having decreased activity into contact with a basic liquid.

(2) The method for activating a catalyst for chlorine production according to (1) above, wherein the basic liquid has a pH of 8 or more.

(3) The method for activating a catalyst for chlorine production according to (1) or (2) above, wherein the basic liquid is an aqueous solution in which an inorganic base is dissolved.

(4) The method for activating a catalyst for chlorine production according to any one of (1) to (3) above, wherein the catalyst for chlorine production is a catalyst containing ruthenium oxide.

(5) A method for producing chlorine by oxidizing hydrogen chloride with oxygen in the presence of a catalyst, wherein a catalyst activated by the method according to any one of (1) to (4) above is used as the catalyst.

### Advantageous Effects of Invention

According to the present invention, a catalyst for chlorine production having decreased activity can be effectively activated, so as to recover the catalytic activity satisfactorily. This allows the catalyst for chlorine production having decreased activity to be reused in a reaction for oxidizing hydrogen chloride with oxygen, thus leading to the production of chlorine which is advantageous in terms of achieving reduction in catalyst cost.

### DESCRIPTION OF EMBODIMENTS

In the method for activating a catalyst for chlorine production according to the present invention, the catalyst to be activated may be any catalyst used in the production of chlorine (i.e., a catalyst for chlorine production) by way of a reaction for oxidizing hydrogen chloride with oxygen (hereinafter sometimes simply also referred to as the “oxidation reaction”), and examples of such catalysts include, but are not particularly limited to, a copper catalyst, a chromium catalyst, and a ruthenium catalyst. Specifically, preferred examples of the copper catalyst include catalysts generally referred to as Deacon catalysts, which are obtained by adding a third component selected from various compounds to copper chloride and potassium chloride. Preferred examples of the chromium catalyst include catalysts containing chromium oxide such as those described in Japanese Patent Laying-Open No. 61-136902, Japanese Patent Laying-Open No. 61-275104, Japanese Patent Laying-Open No. 62-113701, and Japanese Patent Laying-Open No. 62-270405. Preferred examples of the ruthenium catalyst include catalysts containing ruthenium oxide such as those described in Japanese Patent Laying-Open No. 9-67103, Japanese Patent Laying-Open No. 10-338502, Japanese Patent Laying-Open No. 2000-281314, Japanese Patent Laying-Open No. 2002-79093, and Japanese Patent Laying-Open No. 2002-292279.

In the method for activating a catalyst for chlorine production according to the present invention, the catalyst for chlorine production to be activated is preferably a ruthenium catalyst, and particularly a catalyst containing ruthenium oxide, among the catalysts mentioned above. The catalyst containing ruthenium oxide may, for example, be a catalyst consisting essentially of ruthenium oxide, a supported ruthenium oxide in which ruthenium oxide is supported on a carrier such as alumina, titania, silica, zirconia, niobium oxide, or activated carbon, or a composite oxide containing ruthenium oxide and other oxide such as alumina, titania, silica, zirconia, or niobium oxide.

In the method for activating a catalyst for chlorine production according to the present invention, the catalyst to be activated is a catalyst for chlorine production having decreased activity (deteriorated catalyst), although the degree of deterioration of the catalytic activity is not particularly limited.

Further, decrease in catalytic activity of the catalyst for chlorine production used in the reaction for oxidizing hydrogen chloride with oxygen (oxidation reaction) occurs in various cases, as will be described below by way of example, and the cause of the decreased activity of the catalyst to be activated in the present invention is not particularly limited. However, in order to achieve more remarkable effects of the present invention in terms of recovery of the catalytic activity, the catalyst to be activated is preferably a deteriorated catalyst having decreased activity due to catalytic poisoning caused by sulfur in a case iii) described below, where such sulfur is contained in a raw material gas.

Generally, decrease in the catalytic activity of the catalyst for chlorine production used in the reaction for oxidizing hydrogen chloride with oxygen (oxidation reaction) gradually occurs as the reaction time of the oxidation reaction (i.e., the time during which the catalyst has been used) elapses. Additionally, the catalytic activity may decrease due to a thermal load or catalyst poisoning in, for example, the following cases where:

i) control of the reaction temperature is difficult due to a defect or the like in equipment, causing the catalyst to be exposed to high temperatures for a long time;

ii) feeding of oxygen has stopped due to a defect or the like in equipment, causing the catalyst to be brought into contact with hydrogen chloride for a long time in the absence of oxygen;

iii) a raw material gas contains sulfur (specifically, for example, where a gas produced in the oxidation reaction is dehydrated by washing with concentrated sulfuric acid, chlorine is subsequently removed, and the remaining gas is recovered and reused again as a raw material gas for the oxidation reaction, or where a hydrogen chloride gas containing an impurity having a sulfur content (an impurity derived from phosgene such as carbonyl sulfide, hydrogen sulfide, carbon disulfide, sulfur oxide, or the like), which is formed as a by-product in, for example, the production of an isocyanate by reaction of an amine with phosgene is used as a raw material gas for the oxidation reaction);

iv) a raw material gas contains a small amount of an organic substance, and this organic substance has not been completely combusted in the oxidation reaction;

v) a reaction tube, pipe, or the like is corroded by a raw material gas or produced water, and a metal produced thereby adheres to the catalyst; and

vi) a portion of the carrier component in a supported catalyst is scattered and covers active sites of the catalyst.

In the method for activating the catalyst for chlorine production according to the present invention, the catalyst for chlorine production having decreased activity (deteriorated catalyst) is brought into contact with a basic liquid. By subjecting the catalyst to such a contact treatment in which the catalyst is brought into contact with a basic liquid, it is possible to effectively activate the catalyst for chlorine production having decreased activity due to, for example, a thermal load or catalyst poisoning, so as to recover the catalytic activity satisfactorily.

The basic liquid may, for example, be an aqueous solution in which an inorganic base such as sodium hydroxide, calcium carbonate, or ammonia is dissolved, or an aqueous solution in which an organic base such as pyridine, triethylamine, or aniline is dissolved. Alternatively, a base that is liquid at a temperature and pressure at which it is brought into contact with the deteriorated catalyst may be used alone as the basic liquid. Among these, the basic liquid is preferably an aqueous solution in which an inorganic base is dissolved, in view of washing efficiency when the catalyst is subsequently washed with water. When an aqueous solution is used as the basic liquid, highly pure water like ultrapure water is preferably used as a solvent.

The basic liquid has a pH of preferably 8 or more, and more preferably 10 or more. If the basic liquid has a pH less than 8 toward the neutral range, the activation effect may be insufficient, possibly making it impossible to sufficiently recover the catalytic activity.

The method for bringing the deteriorated catalyst into contact with the basic liquid is not particularly limited, and may, for example, be a fixed bed type or a batch type. In the case of a fixed bed type, the feed velocity of the basic liquid, represented as liquid hourly space velocity of the basic liquid per volume of the catalyst (i.e., LHSV), is generally set to about 0.01 to 100 h⁻¹, and the contact treatment time is generally set to about 0.5 to 100 hours. In the case of a fixed bed type, the basic liquid may also be circulated. On the other hand, in the case of a batch type, the amount of the basic liquid used is generally set to about 1 to 100 parts by weight per part by weight of the catalyst, and the contact treatment time is generally set to about 0.5 to 120 hours. When contacting is performed in either type of method, the contact treatment temperature is generally set to 0 to 100° C., and preferably 10 to 90° C., and the contact treatment is generally performed about 1 to 10 times.

In the method for activating the catalyst for chlorine production according to the present invention, the catalyst after being brought into contact with the basic liquid is preferably further washed with water. The amount of water used for washing is preferably 1 time or more, and more preferably 3 times or more, the weight of the basic liquid previously brought into contact. The number of times of washing with water is not particularly limited, and is generally about 1 to 10 times; however, washing is preferably performed until the pH of drainage water after washing is confirmed to have become equivalent to that of the water used for washing. The water used for washing is also preferably highly pure water like ultrapure water.

Furthermore, in the method for activating the catalyst for chlorine production according to the present invention, the catalyst may be dried after being brought into contact with the basic liquid or after being washed thereafter. The drying method and the like are not particularly limited.

The thus-activated catalyst for chlorine production exhibits excellent catalytic activity in a reaction for oxidizing hydrogen chloride with oxygen, and can be reused in this oxidation reaction. This achieves reduction in catalyst cost, allowing chlorine to be produced advantageously in terms of cost.

A method for producing chlorine according to the present invention is a method wherein hydrogen chloride is oxidized with oxygen in the presence of a catalyst activated by the above-described activation method according to the present invention.

The reaction for oxidizing hydrogen chloride with oxygen (oxidation reaction) using the activated catalyst is generally performed continuously under gaseous phase conditions, while feeding a raw material gas composed of hydrogen chloride (gas containing hydrogen chloride) and oxygen (gas containing oxygen) into a fixed bed reactor loaded with the catalyst or a fluid bed reactor in which the catalyst is circulated. Here, it is advantageous to feed steam in addition to hydrogen chloride and oxygen, for example, as described in Japanese Patent Laying-Open No. 2001-19405, because an even temperature distribution in a catalyst layer can be achieved.

The gas containing hydrogen chloride is not particularly limited, and various gases containing hydrogen chloride can be used, for example, a gas produced by the reaction between hydrogen and chlorine, or a gas generated by heating hydrochloric acid, and various by-product gases generated by, for example, the pyrolysis reaction or combustion reaction of a chlorine compound, the carbonylation reaction of an organic compound with phosgene, the chlorination reaction of an organic compound with chlorine, and the production of chlorofluoroalkanes, as well as a flue gas produced from a furnace.

Specific examples of the above-mentioned various reactions that produce the gas containing hydrogen chloride are as follows: examples of the pyrolysis reaction of a chlorine compound include the reaction producing vinyl chloride from 1,2-dichloroethane, and the reaction producing tetrafluoroethylene from chlorodifluoromethane; examples of the carbonylation reaction of an organic compound with phosgene include the reaction producing an isocyanate from an amine, and the reaction producing a carbonate from a hydroxy compound; and examples of the chlorination reaction of an organic compound with chlorine include the reaction producing an allyl chloride from propylene, the reaction producing ethyl chloride from ethane, and the reaction producing chlorobenzene from benzene. Further, examples of the production of chlorofluoroalkanes include the production of dichlorodifluoromethane and trichloromonofluoromethane by the reaction between carbon tetrachloride and hydrogen fluoride, and the production of dichlorodifluoromethane and trichloromonofluoromethane by the reaction of methane, chlorine, and hydrogen fluoride.

Air or pure oxygen may be used as the gas containing oxygen. Pure oxygen can be obtained by a general industrial method such as a pressure swing method or cryogenic separation of air.

In the above-described oxidation reaction, it is necessary that the ratio of hydrogen chloride (gas containing hydrogen chloride) and oxygen (gas containing oxygen) be theoretically ¼ mol of oxygen per mole of hydrogen chloride, in order to completely oxidize hydrogen chloride to chlorine. Generally, however, oxygen is used in an amount 0.1 to 10 times that theoretical amount.

In the above-described oxidation reaction, the feed velocity of the gas containing hydrogen chloride, represented as gas hourly space velocity (at 0° C. and 1 atm.) of the gas per volume of the catalyst layer, i.e., represented as GHSV, is generally set to about 10 to 20000 h⁻¹. On the other hand, the feed velocity of the gas containing oxygen, represented as gas hourly space velocity (at 0° C. and 1 atm.) of the gas per volume of the catalyst layer i.e., represented as GHSV, is generally about 10 to 20000 h⁻¹.

Although the reaction conditions and the like in the oxidation reaction are not particularly limited, the reaction temperature is generally set to 100 to 500° C., and preferably 200 to 400° C., and the reaction pressure is generally set to about 0.1 to 5 MPa.

In the method for producing chlorine according to the present invention, it is preferred to repeatedly perform an activation treatment for activating the deteriorated catalyst by the activation method according to the present invention described above, and the above-described oxidation reaction. When, for example, the oxidation reaction is performed as a fixed bed type, the following procedure may be performed: the oxidation reaction is performed while feeding a raw material gas composed of hydrogen chloride and oxygen into a reactor loaded with the catalyst; when the catalytic activity has decreased to such an extent that continuation of operating is difficult, the feeding of the raw material gas is stopped; the catalyst is subsequently subjected to the above-described activation treatment, with the catalyst being loaded in the reactor; the feeding of the raw material gas is then resumed to perform the oxidation reaction; and thereafter, the activation treatment and the oxidation reaction are repeated as needed. On the other hand, when the oxidation reaction is performed as a fluid bed type, the following procedure may be performed: a portion of the catalyst is continuously or intermittently withdrawn from the reactor while performing the oxidation reaction, subjected to the above-described activation treatment in a separate vessel, and subsequently returned to the reactor, such that the catalyst is circulated between the reactor and the vessel for activation treatment, thereby causing the catalyst to be alternately subjected to the activation treatment and the oxidation reaction.

### EXAMPLES

The present invention will be described in more detail with reference to examples, however, the present invention is not limited thereto.

The feed velocity (mL/min.) of a gas is hereinafter represented as a value at 0° C. and 1 atm., unless otherwise specified.

### Reference Example 1

### Preparation of Catalyst Having Decreased Activity (Deteriorated Catalyst))

First, 50 parts by weight of titanium oxide (“STR-60R” manufactured by Sakai Chemical Industry Co., Ltd.; 100% rutile-type), 100 parts by weight of a-alumina (“AES-12” manufactured by Sumitomo Chemical Co., Ltd.), 13.2 parts by weight of a titania sol (“CSB” manufactured by Sakai Chemical Industry Co., Ltd.; titania content: 38% by weight), and 2 parts by weight of methyl cellulose (“Metolose 65SH-4000” manufactured by Shin-Etsu Chemical Co., Ltd.) were mixed, ion exchange water was subsequently added thereto, and the mixture was kneaded. The kneaded product was extruded into a cylindrical shape having a diameter of 3.0 mm Φ, the molded product was dried, and then fractured to a length of about 4 to 6 mm. The resulting molded product was calcined in air at 800° C. for 3 hours, thus giving a carrier made of a mixture of titanium oxide and α-alumina. Next, this carrier was impregnated with an aqueous solution of ruthenium chloride in an amount to achieve a predetermined content, the resulting material was dried and then calcined in air at 250° C. for 2 hours, thereby giving a bluish gray, supported ruthenium oxide catalyst (fresh catalyst) in which 2% by weight ruthenium oxide was supported on the above carrier.

Analysis of this supported ruthenium oxide (fresh catalyst) by ICP emission spectrometry revealed a sulfur content of 0.02% by weight.

The obtained supported ruthenium oxide catalyst (fresh catalyst) was subsequently charged into a reactor, and the oxidation reaction was performed at 280 to 390° C. over a long period while feeding a raw material gas composed of hydrogen chloride gas (containing 130 ppb by volume of sulfur) and oxygen gas into the reactor, thereby preparing a deteriorated catalyst.

Analysis of the deteriorated catalyst by ICP emission spectrometry revealed a sulfur content of 0.13% by weight.

### Example 1

Five grams of the deteriorated catalyst obtained in Reference Example 1 and 45 g of 2.5% aqueous solution of sodium hydroxide (prepared by diluting 28.125 g of 1 mol/L aqueous solution of sodium hydroxide manufactured by Wako Pure Chemical Industries, Ltd. with 16.875 g of ion exchange water) were placed in a vessel and mixed, and the mixture was allowed to stand for 24 hours at 25° C., thereby bringing both components into contact with each other. The supernatant liquid was subsequently decanted off, and the resulting solid was washed 3 times with 50 g of ion exchange water. Next, in the same manner as described above, the solid was mixed with the 2.5% aqueous solution of sodium hydroxide, the mixture was allowed to stand at 25° C., the supernatant liquid was decanted off, and the resulting solid was subsequently washed with ion exchange water. This operation was repeated twice. Here, the mixture was allowed to stand for 24 hours in the first operation, and for 72 hours in the second operation. Then, the resulting product was dried (for 2 hours or longer) until a constant weight was reached at 60° C., thus giving a catalyst activated by the activation method according to the present invention (activated catalyst). The 2.5% aqueous solution of sodium hydroxide used here was found to have a pH of 13.5 by pH measurement.

Next, catalytic activity obtained when the reaction for oxidizing hydrogen chloride with oxygen was performed using the obtained activated catalyst was evaluated according to a method described below. The results are shown in Table 1.

Further, analysis of the obtained activated catalyst by ICP emission spectrometry revealed a sulfur content of 0.023% by weight. This result shows that the sulfur content can be reduced to the same level as that of the fresh catalyst by the activation method according to the present invention.

<Evaluation of Catalytic Activity>

One gram of the obtained catalyst was loaded into a nickel reaction tube with an inner diameter of 13 mm, and 12 g of α-alumina balls (“SSA995” manufactured by Nikkato Corporation) were further loaded as a preheating layer into the gas inlet side of a catalyst layer. While nitrogen gas was fed into this reaction tube at a velocity of 80 mL/min., the reaction tube was immersed in a salt bath containing a molten salt (potassium nitrate/sodium nitrite=1/1 (weight ratio)) as a heating medium, so as to increase the temperature of the catalyst layer to 281 to 282° C. Next, after the feeding of the nitrogen gas was stopped, hydrogen chloride gas (containing 19 ppb by volume of sulfur) was fed at a velocity of 80 mL/min. (0.21 mol/h), and oxygen gas was fed at a velocity of 40 mL/min. (0.11 mol/h), and the oxidation reaction was performed at a catalyst layer temperature of 281 to 282° C. After 1.5 hours from the start of reaction, sampling was performed by causing the gas at the reaction tube outlet to circulate in a 30% by weight aqueous solution of potassium iodide for 20 minutes, and the amount of chlorine produced was measured by iodometry, so as to determine the velocity of chlorine production (mol/h). From this velocity of chlorine production and the above-mentioned feed velocity of hydrogen chloride (mol/h), the conversion (%) of hydrogen chloride was calculated in accordance with the following equation:

Conversion (%) of hydrogen chloride=[velocity of chlorine production (mol/h)×2÷feed velocity of hydrogen chloride (mol/h)]×100

### Example 2

A catalyst activated by the activation method according to the present invention (activated catalyst) was obtained as in Example 1, except that the 2.5% aqueous solution of sodium hydroxide used in Example 1 was replaced with 2.5% aqueous solution of sodium carbonate (prepared by dissolving 1.125 g of sodium carbonate manufactured by Wako Pure Chemical Industries, Ltd. in 43.875 g of ion exchange water). It is noted that the 2.5% aqueous solution of sodium carbonate used here was found to have a pH of 11.15 by pH measurement.

Next, catalytic activity obtained when the reaction for oxidizing hydrogen chloride with oxygen was performed using the obtained activated catalyst was evaluated according to the method described above. The results are shown in Table 1.

Further, analysis of the obtained activated catalyst by ICP emission spectrometry revealed a sulfur content of 0.035% by weight. This result shows that the sulfur content can be reduced to substantially the same level as that of the fresh catalyst, by the activation method according to the present invention.

### Comparative Example 1

Catalytic activity obtained when the reaction for oxidizing hydrogen chloride with oxygen was performed using the deteriorated catalyst obtained in Reference Example 1 was evaluated according to the same method as in Example 1. The results are shown in Table 1.

### Comparative Example 2

Five grams of the deteriorated catalyst obtained in Reference Example 1 and 45 g of ion exchange water were placed in a vessel and mixed, and the mixture was allowed to stand for 24 hours at 25° C., thereby bringing both components into contact with each other. Then, the supernatant liquid was decanted off to afford a solid, the solid was subsequently placed in the vessel again together with 45 g of ion exchange water, the mixture was allowed to stand at 25° C., and the supernatant liquid was decanted off. This operation was repeated twice. Here, the mixture was allowed to stand for 24 hours in the first operation, and for 72 hours in the second operation. The resulting product was subsequently dried (for 2 hours or longer) until a constant weight was reached at 60° C., thus giving a water-treated catalyst.

Next, catalytic activity obtained when the reaction for oxidizing hydrogen chloride with oxygen was performed using the obtained catalyst was evaluated according to the same method as in Example 1. The results are shown in Table 1. Further, analysis of the obtained catalyst by ICP emission spectrometry revealed a sulfur content of 0.088% by weight.

### Comparative Example 3

One gram of the deteriorated catalyst obtained in Reference Example 1 was loaded into a nickel reaction tube with an inner diameter of 13 mm, and 12 g of α-alumina balls (“SSA995” manufactured by Nikkato Corporation) were further loaded as a preheating layer into the gas inlet side of a catalyst layer. While nitrogen gas was fed into this reaction tube at a velocity of 80 mL/min., the reaction tube was immersed in a salt bath containing a molten salt (potassium nitrate/sodium nitrite=1/1 (weight ratio)) as a heating medium, so as to increase the temperature of the catalyst layer to 350° C. Next, after the feeding of the nitrogen gas was stopped, the catalyst layer was maintained for 2 hours at 350° C. while carbon monoxide gas was fed at a velocity of 3.2 mL/min. (0.009 mol/h), and nitrogen gas was fed at a velocity of 28.8 mL/min. (0.08 mol/h), thereby performing a contact treatment with the reducing gas.

Next, subsequent to the above-described contact treatment with the reducing gas, a contact treatment with an oxidizing gas was performed. That is, after the feeding of the carbon monoxide gas was stopped, the catalyst layer was maintained for 2 hours at 350° C. while oxygen gas was fed at a velocity of 40 mL/min. (0.009 mol/h), and nitrogen gas was fed at a velocity of 160 mL/min. (0.43 mol/h), thereby performing a contact treatment with the oxidizing gas. This afforded a catalyst subjected to the contact treatment with the oxidizing gas, after the contact treatment with the reducing gas.

Next, without removing the obtained catalyst from the reaction tube, catalytic activity obtained when the reaction for oxidizing hydrogen chloride with oxygen was evaluated, subsequent to the above-described contact treatment with the oxidizing gas. That is, the feeding of the oxygen gas was stopped, and the feed velocity of the nitrogen gas was set to 80 mL/min. (0.21 mol/h), after which the temperature of the catalyst layer was set to 281 to 282° C. Next, thereafter in accordance with the evaluation of catalytic activity in Example 1, after the feeding of the nitrogen gas was stopped, hydrogen chloride gas and oxygen gas were fed to perform oxidation reaction, after which the amount of chlorine produced was measured, and the conversion (%) of hydrogen chloride was calculated. The results are shown in Table 1.

TABLE 1

| | | Sulfur | Conversion of |
|---|---|---|---|
| | | Content | Hydrogen Chloride |
| | Activation Treatment | (wt. %) | (%) |
| Ex. 1 | 2.5% Aqueous Solution of | 0.023 | 4.31 |
| | Sodium Hydroxide | | |
| Ex. 2 | 2.5% Aqueous Solution of | 0.035 | 3.40 |
| | Sodium Carbonate | | |
| Com. | None | 0.13 | 1.65 |
| Ex. 1 | | | |
| Com. | Water | 0.088 | 1.80 |
| Ex. 2 | | | |
| Com. | Reducing Gas → Oxidizing | — | 2.96 |
| Ex. 3 | Gas | | |

1. A method for activating a catalyst for chlorine production used in a reaction for oxidizing hydrogen chloride with oxygen, comprising the step of bringing a catalyst for chlorine production having decreased activity into contact with a basic liquid.

2. The method for activating a catalyst for chlorine production according to claim 1, wherein
said basic liquid has a pH of 8 or more.

3. The method for activating a catalyst for chlorine production according to claim 1, wherein
said basic liquid is an aqueous solution in which an inorganic base is dissolved.

4. The method for activating a catalyst for chlorine production according to claim 1, wherein
said catalyst for chlorine production is a catalyst containing ruthenium oxide.

5. A method for producing chlorine by oxidizing hydrogen chloride with oxygen in the presence of a catalyst, wherein
a catalyst activated by the method according to claim 1 is used as said catalyst.
